(19) United States
(12) Patent Application Publication
(10) Pub. No.: US 2020/0356599 A1
(43) Pub. Date: Nov. 12, 2020

(54) SYSTEMS AND METHODS FOR GRAPH-BASED QUERY ANALYSIS

(71) Applicant: Huawei Technologies Co., Ltd., Shenzhen (CN)

(72) Inventors: Yinglong Xia, San Jose, CA (US); Rong Duan, Summit, NJ (US); Ting Yu Leung, San Jose, CA (US)

(21) Appl. No.: 16/947,288

(22) Filed: Jul. 27, 2020

Related U.S. Application Data
(63) Continuation of application No. PCT/CN2019/106563, filed on Sep. 19, 2019.
(60) Provisional application No. 62/733,998, filed on Sep. 20, 2018.

(51) Int. Cl. G06F 16/901; G06F 16/21; G06F 16/28

(52) U.S. Cl. CPC G06F 16/9024; G06F 16/288; G06F 16/287; G06F 16/219

(57) ABSTRACT

A computer-implemented method of determining data lineage based on database queries is provided. A received database query is parsed to identify a plurality of data entities associated with a plurality of data flows. A query graph associated with the received database query is generated, where the query graph includes a plurality of nodes connected via edges. The plurality nodes correspond to the plurality of data entities and the edges correspond to the plurality of data flows. A data lineage query is retrieved from memory. The data lineage query includes one or more of the plurality of data entities associated with the plurality of nodes within the generated query graph. A representation of the generated query graph is output based on the data lineage query.

### CROSS-REFERENCE TO RELATED APPLICATIONS

This application is a continuation application of International Application No. PCT/CN2019/106563, filed Sep. 19, 2019, which claims priority to the U.S. Provisional Patent Application Ser. No. 62/733,998, filed Sep. 20, 2018, the contents of both of which are incorporated herein by reference in their entirety.

### TECHNICAL FIELD

The present disclosure is related to data lineage management and, in particular, to systems and methods for graph-based query analysis for fine-grained data lineage management.

### BACKGROUND

Data lineage is the gene of data, which describes what happens to data as it goes through diverse processes and data manipulations. More specifically, data lineage provides visibility into the analytics pipeline and simplifies tracing errors back to their sources. Enterprises nowadays can use data lineage analysis for finding possible causality when an anomaly is detected in final data reports, or for evaluating the impact due to the modification of a data table. Such data management and analysis tasks can be crucial for maintaining the normal operation of a business.

In a “big data” environment, there can be many data sources for an enterprise that may need to be merged, joined, filtered, etc., to generate data reports periodically, which results in increased complexity when maintaining the data lineage. Therefore, tools for representing, managing, and evaluating data lineage can be essential for a company.

### SUMMARY

Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to a first aspect of the present disclosure, there is provided a computer-implemented method of determining data lineage based on database queries. A received database query is parsed to identify a plurality of data entities associated with a plurality of data flows. A query graph is generated based on the received database query. The query graph includes a plurality of nodes connected via edges. The plurality nodes correspond to the plurality of data entities, and the edges correspond to the plurality of data flows. A data lineage query is retrieved from memory. The data lineage query includes one or more of the plurality of data entities associated with the plurality of nodes within the generated query graph. A representation of the generated query graph is output based on the data lineage query.

In a first implementation form of the method according to the first aspect as such, at least a second query graph is retrieved, where the second query graph includes at least one node that is common with the generated query graph.

In a second implementation form of the method according to the first aspect as such or any preceding implementation form of the first aspect, the at least one node that is common with the generated query graph includes at least one of the following: a data table, a table column, a data view, a query result set, and a user-defined function. In this regard, by modeling the user-defined tables, columns, and data transformation (including user-defined functions) in connections with generating the query graph, fine-grained operations can be noticed in the graph, allowing for fine-grained data analysis associated with data lineage.

In a third implementation form of the method according to the first aspect as such or any preceding implementation form of the first aspect, a combined property graph is generated based on the query graph and the second query graph. The combined property graph traces data lineage of data from a starting node within the query graph through the at least one common node and terminating at a node that outputs a final representation of the data. In this regard, query graphs can be aggregated by merging the vertices/nodes referring to the same entities (e.g. data tables, UDF, etc.), which can be beneficial to generate an aggregated property graph, so that all impact paths are naturally presented in a lineage graph with high-performance access optimization. Furthermore, an added benefit is that data lineage analysis can be performed on the aggregated lineage graph, resulting in a more detailed data lineage report that can be generated based on a data lineage query performed in connection with the aggregated property graph.

In a fourth implementation form of the method according to the first aspect as such or any preceding implementation form of the first aspect, a graph visualization or JavaScript Object Notation (JSON) is output using the combined property graph and based on the data lineage query. The graph visualization is based on at least one portion of the combined property graph that includes nodes corresponding to the plurality of data entities referenced in the query.

In a fifth implementation form of the method according to the first aspect as such or any preceding implementation form of the first aspect, the data lineage query is translated into one or more graph query languages compatible with the generated query graph.

In a sixth implementation form of the method according to the first aspect as such or any preceding implementation form of the first aspect, a plurality of attributes for the plurality of data entities are detected. The plurality of nodes corresponding to the plurality of data entities is appended with the plurality of attributes.

In a seventh implementation form of the method according to the first aspect as such or any preceding implementation form of the first aspect, the received database query is validated before the parsing. The validated query is executed to generate a query report.

In an eighth implementation form of the method according to the first aspect as such or any preceding implementation form of the first aspect, the validated query is executed concurrently with generating the query graph.

In a ninth implementation form of the method according to the first aspect as such or any preceding implementation form of the first aspect, one or more of the plurality of data flows are detected as associated with data operations that manipulate data without affecting the query report.

In a tenth implementation form of the method according to the first aspect as such or any preceding implementation form of the first aspect, the one or more of the plurality of data flows are excluded from the query graph.

In an eleventh implementation form of the method according to the first aspect as such or any preceding implementation form of the first aspect, the database query includes a nested query, and one of the plurality of nodes within the query graph is associated with a structured query language (SQL) operation of the nested query.

According to a second aspect of the present disclosure, there is provided a device including a memory storage with instructions, and one or more processors in communication with the memory storage. The one or more processors execute the instructions to perform operations including parsing a received database query to identify a plurality of data entities associated with a plurality of data flows. A query graph is generated based on the received database query, the query graph including a plurality of nodes connected via edges. The plurality nodes correspond to the plurality of data entities and the edges correspond to the plurality of data flows. A data lineage query is retrieved from memory, where the data lineage query includes one or more of the plurality of data entities associated with the plurality of nodes within the generated query graph. A representation of the generated query graph is output based on the data lineage query.

In a first implementation form of the device according to the second aspect as such, the one or more processors execute the instructions to perform operations further including retrieving at least a second query graph. The second query graph includes at least one node that is common with the generated query graph.

In a second implementation form of the device according to the second aspect as such or any preceding implementation form of the second aspect, the one or more processors execute the instructions to perform operations further including generating a combined property graph based on the query graph and the second query graph.

In a third implementation form of the device according to the second aspect as such or any preceding implementation form of the second aspect, the one or more processors execute the instructions to perform operations further including outputting a graph visualization or JavaScript Object Notation (JSON) using the combined property graph and based on the data lineage query.

In a fourth implementation form of the device according to the second aspect as such or any preceding implementation form of the second aspect, the one or more processors execute the instructions to perform operations further including detecting a plurality of attributes for the plurality of data entities.

In a fifth implementation form of the device according to the second aspect as such or any preceding implementation form of the second aspect, the one or more processors execute the instructions to perform operations further including appending the plurality of nodes corresponding to the plurality of data entities with the plurality of attributes.

In a sixth implementation form of the device according to the second aspect as such or any preceding implementation form of the second aspect, the one or more processors execute the instructions to perform operations further including detecting one or more of the plurality of data flows are associated with data operations that manipulate data without affecting a query report resulting from executing the database query.

In a seventh implementation form of the device according to the second aspect as such or any preceding implementation form of the second aspect, the one or more processors execute the instructions to perform operations further including excluding the one or more of the plurality of data flows from the query graph.

According to a third aspect of the present disclosure, there is provided a non-transitory computer-readable medium storing instructions for determining data lineage based on database queries, that when executed by one or more processors, cause the one or more processors to perform operations. The operations include parsing a received database query to identify a plurality of data entities associated with a plurality of data flows. A query graph is generated based on the received database query, the query graph including a plurality of nodes connected via edges. The plurality nodes correspond to the plurality of data entities and the edges correspond to the plurality of data flows. A data lineage query is retrieved from memory. The data lineage query includes one or more of the plurality of data entities associated with the plurality of nodes within the generated query graph. A representation of the generated query graph is output based on the data lineage query.

In a first implementation form of the non-transitory computer-readable medium according to the third aspect as such, the instructions further cause the one or more processors to perform operations including detecting a plurality of attributes for the plurality of data entities; and

In a second implementation form of the non-transitory computer-readable medium according to the third aspect as such or any preceding implementation form of the third aspect, the instructions further cause the one or more processors to perform operations including appending the plurality of nodes corresponding to the plurality of data entities with the plurality of attributes.

Any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1A is an illustration of multiple data lineage representations within a data warehouse using multiple data management systems, according to some example embodiments.

FIG. 1B is an example data lineage representation from the data warehouse of FIG. 1A, according to some example embodiments.

FIG. 2 is an illustration of a data processing architecture providing graph-based query analysis, according to some example embodiments.

FIG. 3 is a block diagram of a graph database module used in connection with query graph generation and processing by the architecture of FIG. 2, according to some example embodiments.

FIG. 4 is a block diagram illustrating the extraction of example nodes and edges for a query graph using a database query, according to some example embodiments.

FIG. 5A is an illustration of a processing flow for node and edge extraction, according to some example embodiments.

FIG. 5B is an illustration of node extraction using a sample database query and based on the processing flow of FIG. 5A, according to some embodiments.

FIG. 6 is an illustration of a query graph generated using a first database query, according to some example embodiments.

FIG. 7 is an illustration of a query graph generated using a second database query, according to some example embodiments.

FIG. 8 is an illustration of a query graph generated using a third database query, according to some example embodiments.

FIG. 9 is an illustration of a query graph generated using a fourth database query, according to some example embodiments.

FIG. 10 is an illustration of an example property graph generated by aggregating multiple query graphs, according to some example embodiments.

FIG. 11 is a block diagram illustrating circuitry for clients and servers that implement algorithms and perform methods, according to some example embodiments.

FIG. 12 is a flowchart of a method suitable for graph-based query analysis, according to some example embodiments.

### DETAILED DESCRIPTION

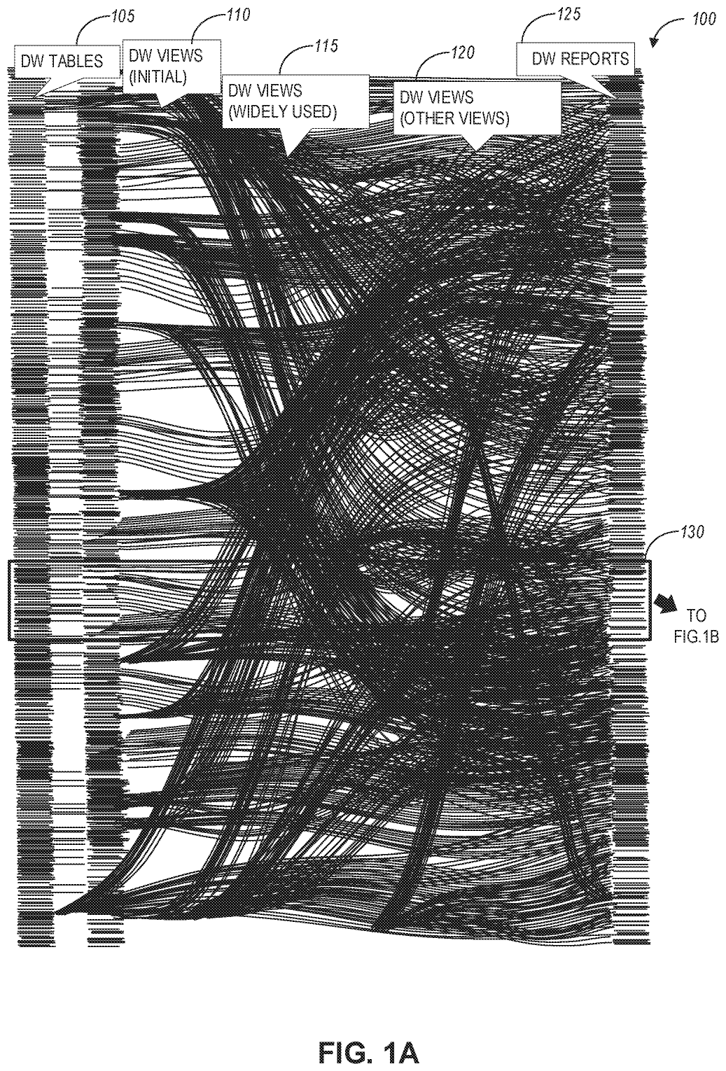

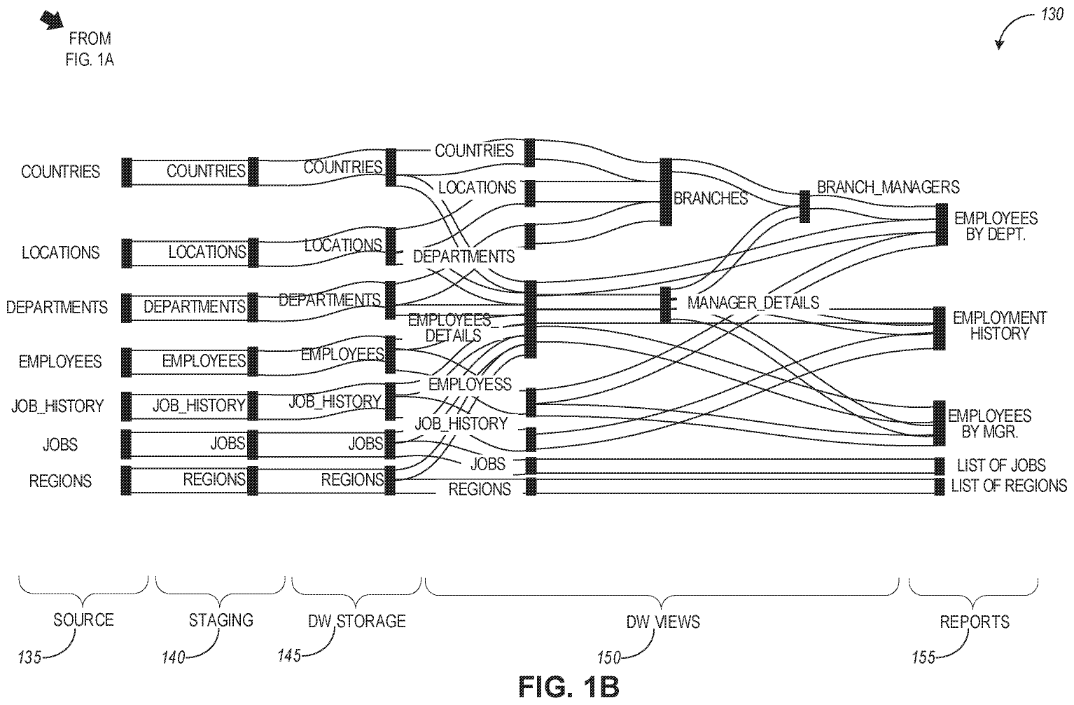

It should be understood at the outset that although an illustrative implementation of one or more embodiments is provided below, the disclosed systems and methods described for FIGS. 1A-12 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized, and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or another type of processor operating on a computer system, such as a switch, server, or another computer system, turning such a computer system into a specifically programmed machine.

As used herein, the term “data lineage” indicates a representation of what happens to data as it undergoes various processes, such as data manipulations, aggregations, and so forth. In an aspect, data lineage can be represented on a graph (e.g., FIG. 1A and FIG. 1B) as a line, originating at a starting point of data processing (e.g., starting at the source of data), and tracing through other data sources or data-related functions or operations, terminating at a final destination of the data (e.g., an output table or view).

As used herein, the term “coarse-grained analysis” indicates data analysis techniques that can be used to analyze data lineage up to the level of a database table. As used herein, the term “fine-grained analysis” indicates data analysis techniques that can be used to analyze data lineages beyond a database table, such as table sub-components including table columns and fields. As used herein, the terms “node” and “vertex” are interchangeable and indicate a stateful entity within a graph (i.e., a data-related entity that can be characterized by a specific state, properties, and/or attributes). As used herein, the terms “edge” or “arc” are interchangeable and indicate a connection between two nodes, signifying a specific data transformation or other data manipulation taking place between the nodes.

There are challenges in managing data lineage in current enterprises. For example, existing data lineage tools are typically coarse-grained analysis tools provided by a particular data management system, resulting in limited capabilities. More specifically, data lineage analysis can be difficult with conventional data lineage tools in aspects when two or more different database systems are used (in reality, a business platform usually consists of several database systems). Additionally, currently-used coarse-grained data lineage management and analysis tools lead to a high rate of false alarms due to the presence and impact of wide tables within the analyzed databases. Therefore, a cross-system data lineage management with high usability and fine-grained data analysis is needed.

Techniques disclosed herein can be used to provide fine-grained data lineage analysis based on query graph representation and aggregation. More specifically, techniques for graph-based query analysis can include three components. Firstly, a fine-grained query graph is generated from a database query. A query is parsed and decomposed to identify stateful entities—e.g., any objects that can be created by users in a data management system, including tables (external, internal and temporal), columns, view, stored procedures, query result sets, user-defined functions (UDFs), and so forth. Each of the stateful entities can be assigned a graph node. An edge in the graph can be a connection between two nodes and can represent data flow between the nodes or a data transformation. Additional properties can be assigned to each node, where the properties can include attributes and descriptions. By modeling the user-defined tables, columns, and data transformation (including user-defined functions), fine-grained operations can be noticed in the graph, allowing for fine-grained data analysis associated with data lineage. Secondly, query graphs can be aggregated by merging the vertices/nodes referring to the same entities (e.g. data tables, UDF, etc.) to generate an aggregated property graph, so that all impact paths are naturally presented in a lineage graph with high-performance access optimization. Thirdly, data lineage analysis can be performed on the aggregated lineage graph, and a data lineage report can be generated based on a data lineage query performed in connection with the aggregated property graph.

Existing data lineage tools are specific to a certain database management system, and a business platform can consist of multiple and different database systems. Existing data lineage analysis tools perform only coarse-grained data analysis (e.g., based on a database table being the smallest analysis component), which introduces many false alarms when data lineage trace is performed. By using techniques disclosed herein, fine-grained lineage analysis can be performed by generating a lineage graph based on database queries where user-defined components (including table sub-components, such as columns and fields) are represented by individual nodes, allowing for fine-grained and efficient data lineage analysis.

FIG. 1A is an illustration of multiple data lineage representations within a data warehouse using multiple data management systems, according to some example embodiments. Referring to FIG. 1A, the data lineage representations can include initial or starting points at data warehouse (DW) tables 105, which can represent the starting point of data processing within the data warehouse 100. Various data manipulations can be performed on tables 105, such as data manipulations generating initial DW views 110. Subsequent data processing can generate additional views, such as DW views 115 and 120. During a final processing stage, DW reports 125 (or other output views or representations) can be output. The multiple lines that are visible in FIG. 1A represent multiple data lineages, with each line tracing the movement/processing of data from a starting/originating data source to a destination (e.g., a table or a view). An example of data lineage representation 130 of several visible data lineages is illustrated in greater detail in FIG. 1B.

FIG. 1B is an example data lineage representation from the data warehouse of FIG. 1A, according to some example embodiments. Referring to FIG. 1B, the data lineage representation 130 illustrates a starting data source 135, which can include multiple different data tables (e.g., Countries, Locations, Departments, Employees, Job_History, Jobs, and Regions). As multiple data management systems within the data warehouse 100 perform data manipulations on the starting data source 135, data is transformed into different views and is output in one or more final reports. For example, data staging 140, data storage 145, and generation of DW views 150 can be performed on the starting data source 135. Final reports 155 can be generated based on the DW views 150. The final reports 155 can include one or more discrepancies, and it can be difficult to trace back the discrepancy to one or more of the sources 135 using conventional coarse-grained data analysis tools. In some aspects, techniques disclosed herein can be used to perform query-based data lineage analysis, including fine-grained data lineage analysis to detect/identify discrepancies or execute data lineage related queries.

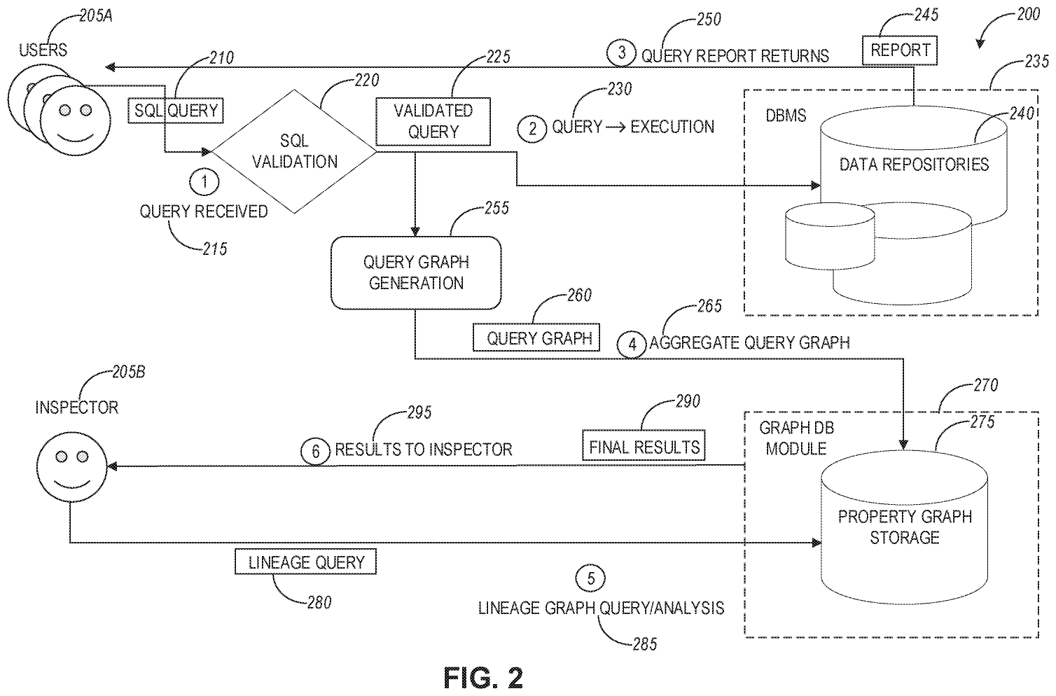

FIG. 2 is an illustration of a data processing architecture providing graph-based query analysis, according to some example embodiments. Referring to FIG. 2, the data processing architecture 200 can be used to process database queries within a database management system as well as to generate aggregate query graphs for purposes of responding to data lineage queries. At operation 215, a database query 210 is received from one or more users 205A. The database query 210 can include a standard query language (SQL) query or another type of query. At operation 220, SQL validation can be performed and a validated query 225 is generated. At operation 230, the validated query 225 can be executed in connection with the database management system (DBMS) 235. The DBMS 235 can include one or more data repositories 240. As a result of the execution of the validated query 225, a query report 245 is generated and communicated back to the one or more users 205A at operation 250.

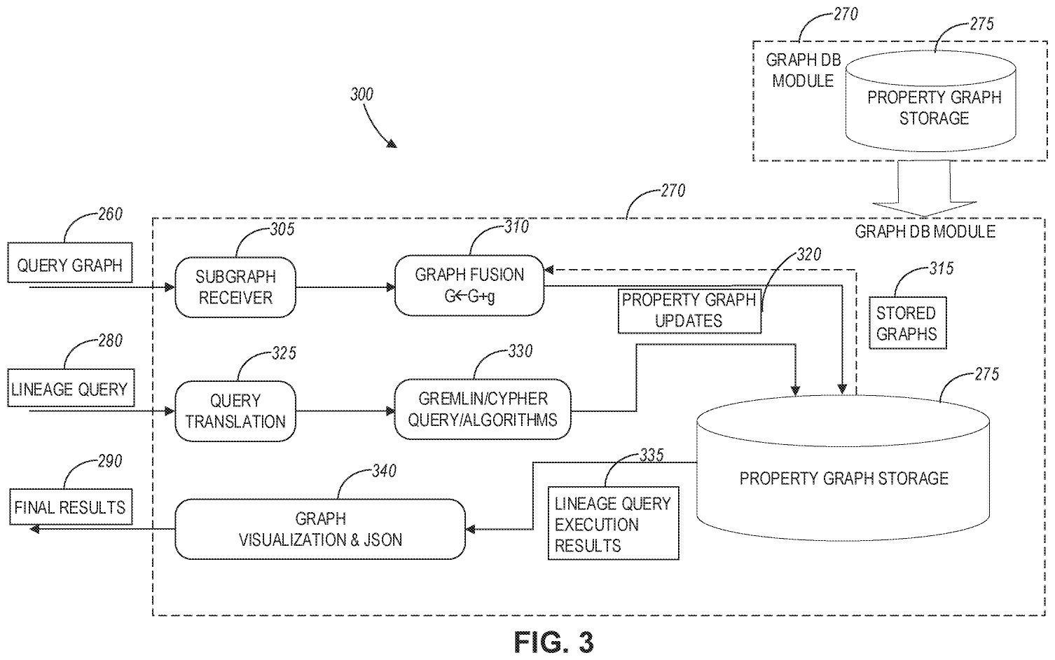

In some aspects, the validated query 225 is also used for query graph generation 255, resulting in a query graph 260. In an example embodiment, the query graph generation 255 can take place concurrently with the query execution 230. At operation 265, the query graph 260 can be aggregated with one or more previously generated query graphs stored within the property graph storage 275 of the graph database module 270 to generate one or more property graphs (details of the graph database module 270 are illustrated in greater detail in FIG. 3). A different user, such as inspector 205B, can communicate a data lineage query 280 for analyzing data lineage in connection with property graphs stored by the graph database module 270. At operation 285, one or more property graphs stored by the property graph storage 275 can be analyzed based on the lineage query 280 to generate final results 290. The final results 290 are returned to the inspector 205B at operation 295.

FIG. 3 is a block diagram of a more detailed view 300 of a graph database module used in connection with query graph generation and processing by the architecture of FIG. 2, according to some example embodiments. Referring to FIG. 3, the query graph 260 is received by the RF receiver 305 within the graph database module 270. The subgraph receiver 305 includes suitable interfaces, circuitry, and/or code configured to perform initial processing of the query graph 260, such as node and edge detection/identification. The query graph 260 as well as the information regarding the detected/identified nodes and edges are communicated to the graph fusion module 310.

The graph fusion module 310 includes suitable interfaces, circuitry, and/or code configured to aggregate query graphs to generate a property graph. More specifically, the graph fusion module 310 retrieves one or more stored graphs 315 (e.g., based on the detected/identified nodes and edges within the query graph 260) and performs graph aggregation with the query graph 260 to generate a property graph 320. The property graph 320 is then stored back in the property graph storage 275.

The data lineage query 280 is received by the query translation module 325. The query translation module 325 includes suitable interfaces, circuitry, and/or code configured to perform translation of the lineage query 280 from a data query language to a graph query language (e.g., Gremlin or Cypher) using graph query algorithms 330. The translated data lineage query is executed to generate lineage query execution results 335. The lineage query execution results 335 can be further reformatted to generate final results 290 that are communicated to the inspector 205B. For example, the lineage query execution results 335 can be reformatted by the graph visualization module 340, which can be configured to reformat the results 335 into a JavaScript Object Notation (JSON) or another type of visualization for presentation to the inspector 205B.

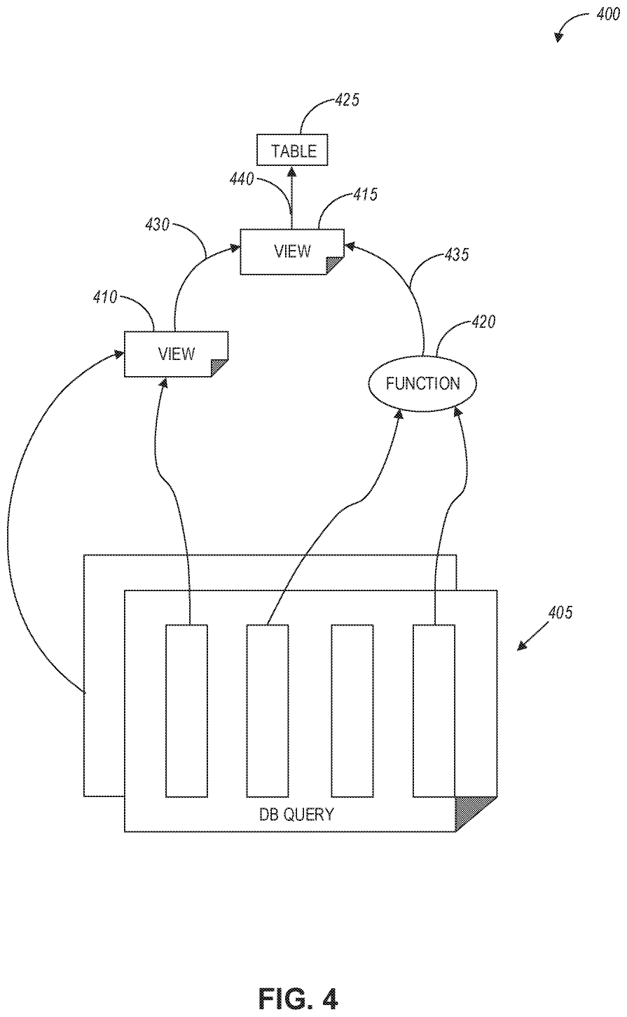

FIG. 4 is a block diagram 400 illustrating extraction of example nodes and edges for a query graph using a database query, according to some example embodiments. Referring to FIG. 4, there is illustrated an example database query 405, which can include data-related entities. As used herein, the term “data-related entity” includes a user-created object with a specific state within a data processing system, such as a table (e.g., external, internal, and temporal), a table column, a data view, a table row, a stored procedure, a query result set, a user-defined function (UDF), and so forth. The data-related entity can be further characterized by properties, which can include attributes and descriptions.

As seen in FIG. 4, the database query 405 can be analyzed for data-related entities, and those entities can be extracted as nodes (or vertices) within a query graph. For example, data views 410 and 415, table 425, and user-defined function 420 can be detected (e.g., identified) as stateful data-related entities (i.e., data-related entities characterized by a given state and properties). The database query 405 can be further analyzed to determine data flows and transformations taking place between the data-related entities. Such data flows and transformations can be represented as edges or arcs between the nodes. For example, data flows or transformations 430, 435, and 440 are referenced in FIG. 4 as edges connecting nodes 410, 415, 420, and 425.

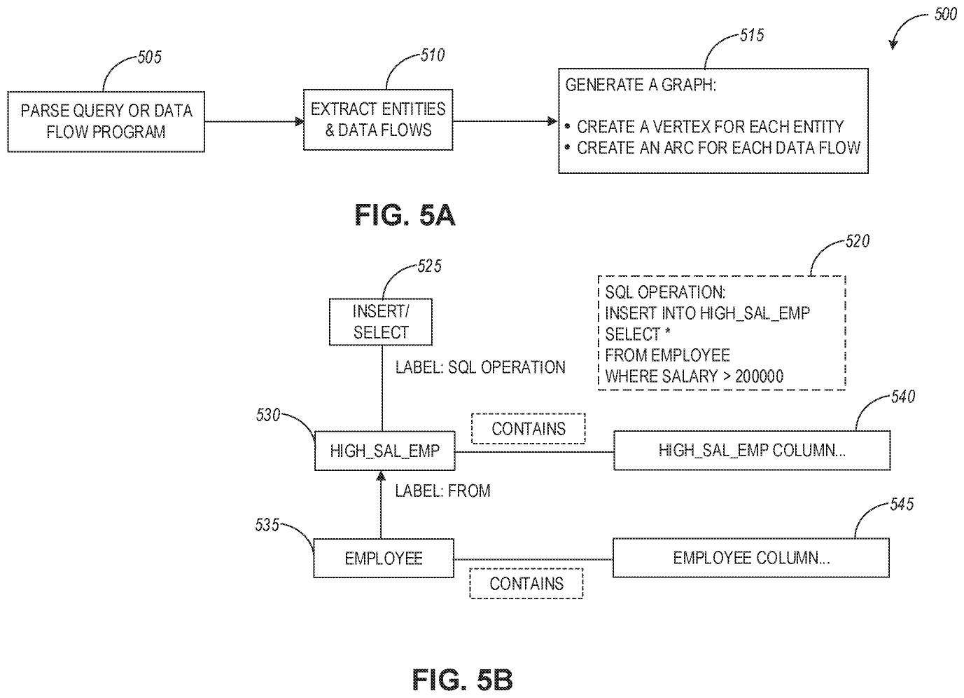

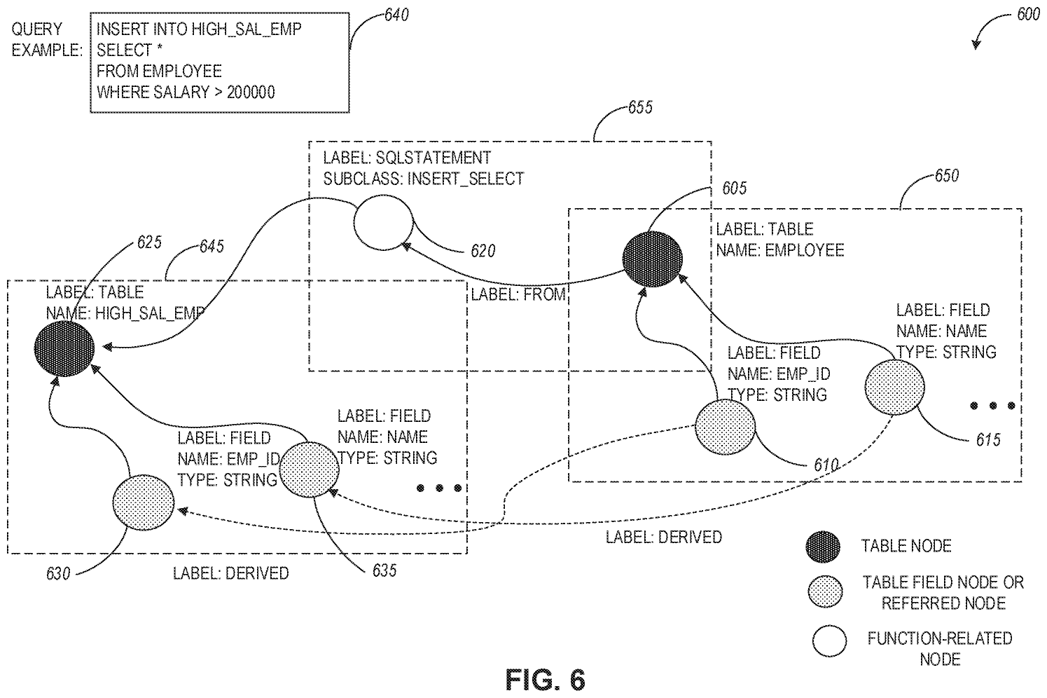

FIG. 5A is an illustration of a processing flow 500 for node and edge extraction, according to some example embodiments. FIG. 5B is an illustration of node extraction using a sample database query and based on the processing flow of FIG. 5A, according to some embodiments. Referring to FIG. 5A, an example database query 520 can be parsed at operation 505. At operation 510, entities and data flows can be extracted from the parsed query 520. More specifically and in connection with the query 520, table HIGH-SAL-EMP and table EMPLOYEE can be extracted as entities 530 and 535, respectively. Additionally, each of the tables HIGH-SAL-EMP and EMPLOYEE include at least one column, which is indicated as entities 540 and 545, respectively. The SQL operation of the query (e.g., INSERT/SELECT) can be extracted as entity 525. At operation 515, a query graph can be generated based on the extracted entities (a vertex or node is created for each entity) and data flows or transformations between the entities (an edge or arc is created for each data flow or transformation). An example query graph in connection with query 520 is illustrated in FIG. 6.

FIG. 6 is an illustration of a query graph 600 generated using a first database query, according to some example embodiments. Referring to FIG. 6, query graph 600 can be generated based on the database query 640, which is the same as query 520 in FIG. 5B. Database query 640 can be interpreted as selecting all columns from table EMPLOYEE for employees where salary is greater than $200,000 and inserting the results into a new table HIGH_SAL_EMP. The selecting and inserting function is performed by the SQL statement within the query 640 and, therefore, the SQL statement will be represented by a separate node 620. The originating and destination tables (EMPLOYEE and HIGH_SAL_EMP) will be represented as nodes 605 and 625 respectively.

Both tables HIGH_SAL_EMP and EMPLOYEE have their columns/fields. More specifically, table EMPLOYEE can include columns/fields called EMP_ID, NAME, and so forth. The table HIGH_SAL_EMP is derived from the table EMPLOYEE (i.e., the contents of HIGH_SAL_EMP are derived from EMPLOYEE via the INSERT-with-SELECT statement within the SQL query 640. The table EMPLOYEE columns/fields can be represented as nodes 610 and 615, and the corresponding columns/fields in table HIGH_SAL_EMP, which are derived from table EMPLOYEE, are represented as nodes 630 and 635.

Additionally, one or more of the nodes in the query graph 600 can be annotated with node properties, such as attributes and descriptions. For example, node 620 is annotated with the label “SQL Statement” and subclass “Insert_Select” which describe the SQL operation associated with query 640. Nodes 605 and 625 are annotated with label “Table” to indicate that these are data tables, as well as a “Name” annotation to indicate the table name as used within the query 640. The table columns/fields nodes (e.g., 610, 615, 630, and 635) are annotated with properties such as “Label”, “Name”, and “Type”.

The data transitions and transformations represented by each edge of the query graph 600 can also be annotated with edge properties. For example, the dotted line edges between nodes 610-630 and 615-635 are annotated with label “Derived” to indicate that data is derived from one table into the other.

In some aspects, dashed boxes (or another type of graphical designation) can be placed within the query graph to represent a table or a view. For example and as illustrated in FIG. 6, boxes 645 and 650 represent tables HIGH_SAL_EMP and EMPLOYEE, and box 655 represents a data view associated with the SQL statement of query 640.

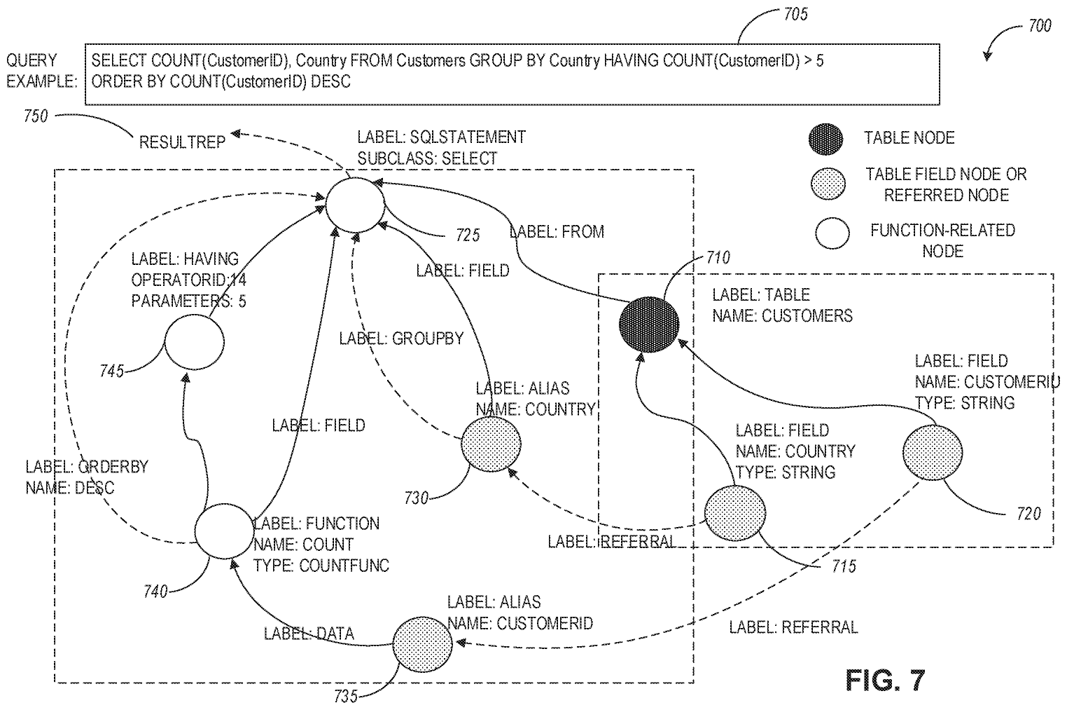

FIG. 7 is an illustration of a query graph 700 generated using a second database query 705, according to some example embodiments. Referring to FIG. 7, database query 705 relates to the processing of data stored within the table “Customers”. As a result of parsing query 705, a node 710 can be created for table “Customers”, and additional nodes 715 and 720 can be created for columns “Country” and “CustomerID” of table “Customers.” A separate node 725 is created for the SQL statement of query 705. Since data from the “Country” and “CustomerID” columns of table “Customers” is used by the SQL statement of query 705, referral nodes 730 and 735 (corresponding to nodes 715 and 720 respectively) can be created so that data related functions of query 705 can be illustrated as edges associated with nodes 730 and 735.

The operation of determining a count of the customer ID column that is greater than five is represented by function nodes 740 and 745. For example, node 745 represents the “HAVING . . . >5” filtering operation, with operator ID 14 corresponding to comparison function “>”, and parameter “5” indicating “>5”. An output the result representation 750 is generated as a result of executing the query 705. Since the result representation 750 is a view (i.e., temporal data) and is not stored in a table, the output arrow from node 725 associated with the result representation 750 is illustrated with a dashed arrow within query graph 700.

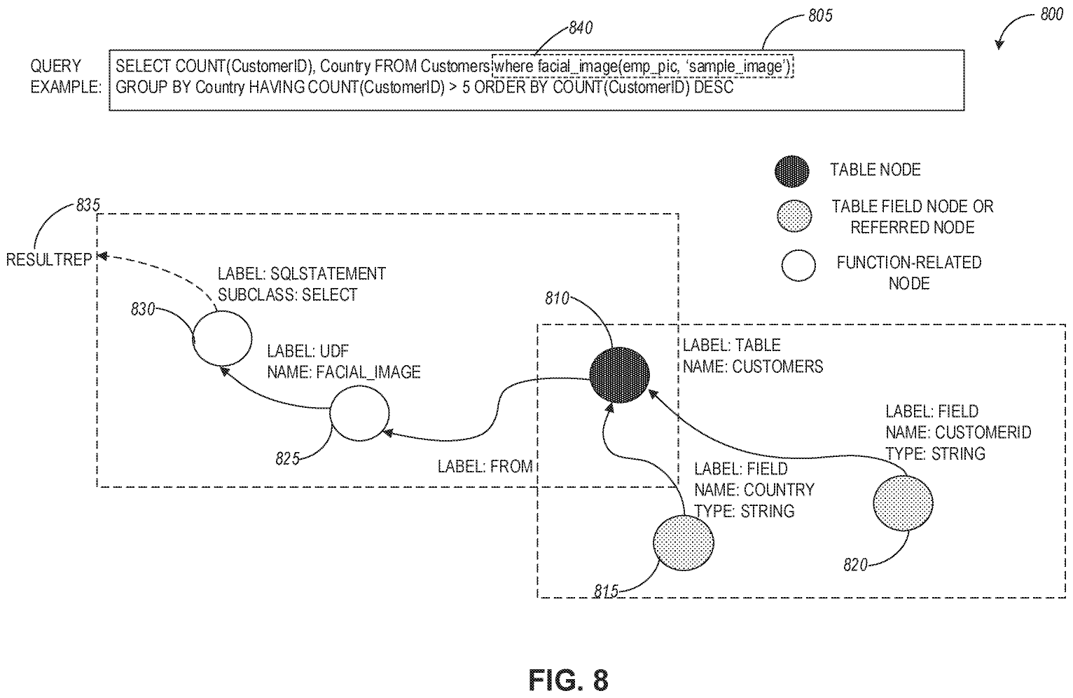

In some aspects, one or more of the node connections within a query graph can be omitted to simplify the graph. For example, the “OrderBy” and “GroupBy” dotted line connections between nodes 740-725 and 730-725 can be omitted from the graph since these connections signify data rearrangement functions that do not ultimately change the query result. A simplified query graph omitting data rearrangement functions is illustrated in FIG. 8.

FIG. 8 is an illustration of a query graph 800 generated using a third database query 805, according to some example embodiments. Referring to FIG. 8, query 805 is similar to query 705, except that query 805 includes an additional user-defined function 840. As a result of parsing query 805, a node 810 can be created for table “Customers”, and additional nodes 815 and 820 can be created for columns “Country” and “CustomerID” of table “Customers.” A separate node 830 is created for the SQL statement of query 805 (i.e., the SELECT function). Since data from the “Country” and “CustomerID” columns of table “Customers” is used by the UDF 840, a separate node 825 for the UDF 840 is created within graph 800. As illustrated in FIG. 8, data rearrangement functions (e.g., ORDER BY and HAVING COUNT>5) can be omitted, simplifying the query graph 800. The output from node 830 is the result representation 835 from the execution of query 805.

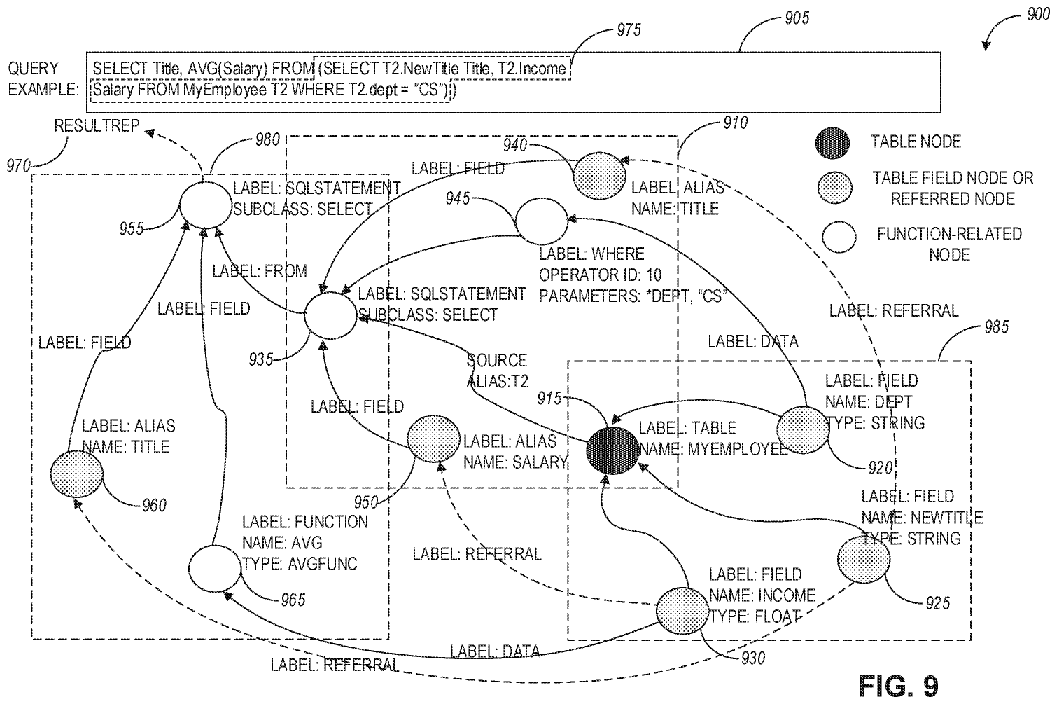

FIG. 9 is an illustration of a query graph 900 generated using a fourth database query 905, according to some example embodiments. Referring to FIG. 9, query 905 includes a nested query (i.e., a query within a query) 975. As a result of parsing query 905, a node 915 can be created for table “MyEmployee”, and additional nodes 920, 925, and 930 can be created for columns “Department”, “New Title”, and “Income”. An outline box 985 can be created within query graph 900 to represent the table “MyEmployee”, including nodes 915, 920, 925, and 930.

A separate node 935 is created for the SQL statement of the nested query 975 (i.e., the SELECT function). Data referral nodes 940 and 950 can be generated, using data from nodes 925 and 930 respectively. The WHERE function within the nested query 975 is associated with node 945 using input from node 920. An outline box 910 can be created within query graph 900 to represent the nested query 975 and its associated data processing and manipulation functions.

A separate node 955 is created for the SQL statement of the main query 905 (i.e., the SELECT function). A data referral node 960 is generated, using referred data from node 925. The AVG function within the query 905 is associated with node 965 using data from node 930. An outline box 980 can be created within query graph 900 to represent the main query 905 and its associated data processing and manipulation functions. The output from node 955 is the result representation 970 from execution of the query 905.

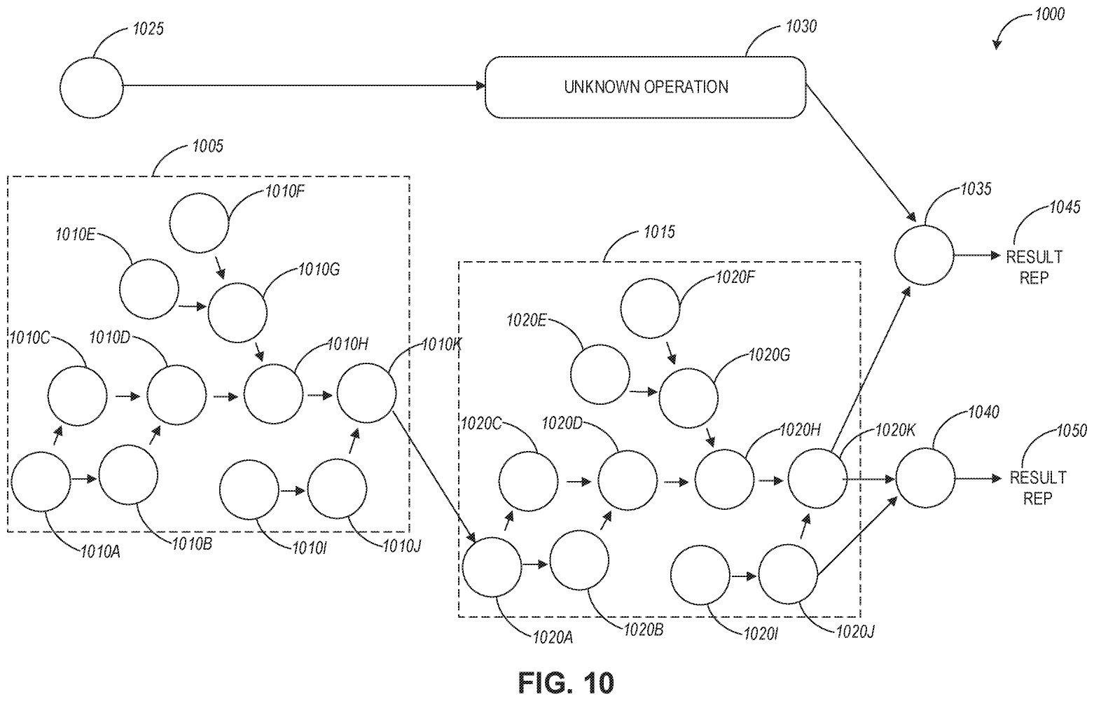

FIG. 10 is an illustration of an example property graph 1000 generated by aggregating multiple query graphs, according to some example embodiments. Referring to FIG. 10, there is illustrated a first query graph 1005, which can be generated with nodes 1010A, 1010B, 1010C, 1010D, 1010E, 1010F, 1010G, 1010H, 1010I, 1010J, and 1010K. A second query graph 1015 can be generated with nodes 1020A, 1020B, 1020C, 1020D, 1020E, 1020F, 1020G, 1020H, 1020I, 1020J, and 1020K.

In an example aspect, individual query graphs can be aggregated to generate an aggregate property graph by locating a common node within the individual query graphs and aggregating the individual graphs around the common node. Individual query graphs can also be aggregated if the output from one query graph is an input to another query graph. Multiple property graphs can also be aggregated based on one or more common nodes.

For example, since the output from node 1010K of query graph 1005 is input to node 1020A of query graph 1015, query graphs 1005 and 1015 can be aggregated. In another aspect, node 1010K can be the same as node 1020A and query graphs 1005 and 1015 can be aggregated based on the common node.

As illustrated in FIG. 10, property graph 1000 further includes node 1025 connected to node 1030 (associated with an unknown operation) and generating output to node 1035. Additionally, outputs from nodes 1020K and 1020J are communicated to node 1040. In this regard, query graphs 1005 and 1015, as well as nodes 1025, 1030, 1035, and 1040 can all be aggregated into property graph 1000. A first result representation 1045 can be output from node 1035, and a second result representation 1050 can be output from node 1040. The property graph representation in FIG. 10 is exemplary and other variations and aggregations of query graphs into property graphs are possible using the techniques described herein.

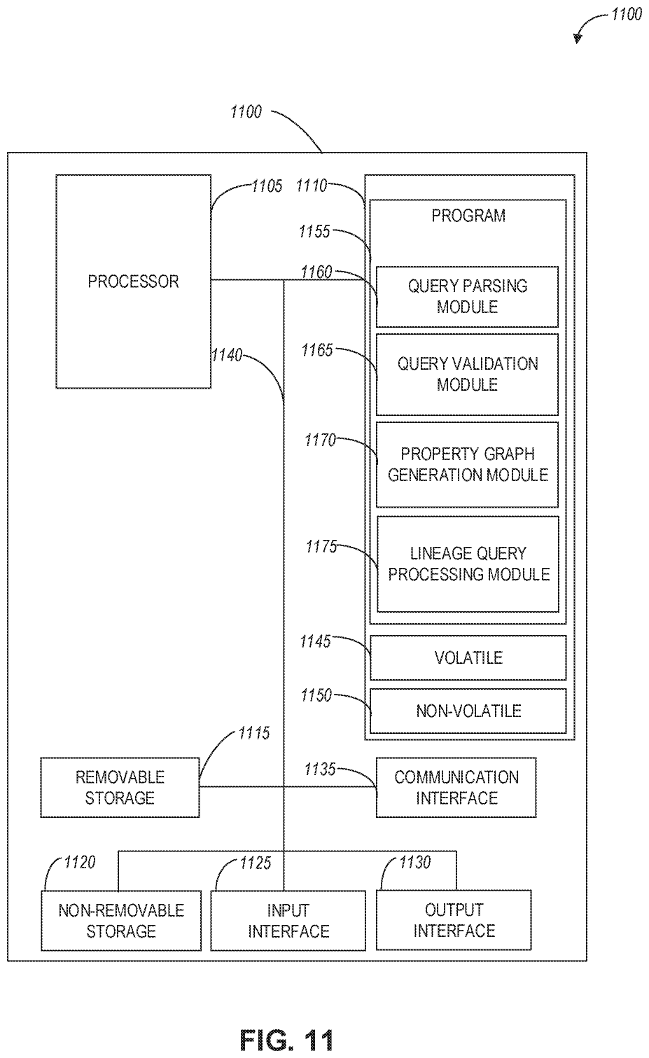

FIG. 11 is a block diagram illustrating circuitry for clients and servers that implement algorithms and perform methods, according to some example embodiments. All components need not be used in various embodiments. For example, the clients, servers, and cloud-based network resources may each use a different set of components, or in the case of servers, larger storage devices.

One example computing device in the form of a computer 1100 (also referred to as computing device 1100 and computer system 1100) may include a processor 1105, memory storage 1110, removable storage 1115, non-removable storage 1120, input interface 1125, the output interface 1130, and communication interface 1135, all connected by a bus 1140. Although the example computing device is illustrated and described as the computer 1100, the computing device may be in different forms in different embodiments.

The memory storage 1110 may include volatile memory 1145 and non-volatile memory 1150 and may store a program 1155. The computer 1100 may include—or have access to a computing environment that includes—a variety of computer-readable media, such as the volatile memory 1145, the non-volatile memory 1150, the removable storage 1115, and the non-removable storage 1120. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 1155 stored in the memory 1110) are executable by the processor 1105 of the computer 1100. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example. As used herein, the terms “computer-readable medium” and “machine-readable medium” are interchangeable.

The program 1155 may utilize a customer preference structure using modules such as a query parsing module 1160, a query validation module 1165, a property graph generation module 1170, and a lineage query processing module 1175. Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The query parsing module 1160 includes suitable circuitry, logic, interfaces, and/or code, and is configured to parse database queries to detect (e.g., identify) data-related entities within the query. Such entities can include a user-created object with a specific state within a data processing system, such as a table (e.g., external, internal, and temporal), a table column, a data view, a table row, a stored procedure, a query result set, a user-defined function (UDF), and so forth. The data-related entity can be further characterized by properties, which can include attributes and descriptions. The query parsing module 1160 is also configured to detect data flows and transformations associated with the database query.

The query validation module 1165 includes suitable circuitry, logic, interfaces, and/or code, and is configured to perform query validation of a received query (e.g., as performed at query validation operation to 20 in FIG. 2).

The property graph generation module 1170 includes suitable circuitry, logic, interfaces, and/or code, and is configured to generate one or more query graphs as well as perform aggregation of query graphs to generate one or more property graphs. More specifically, the property graph generation module 1170 is configured to generate a query graph based on the nodes, edges, and properties obtained by the query parsing module 1160. The property graph generation module 1170 can perform the same functions as query graph generation 255 in FIG. 2, subgraph receiver 305 functions, graph fusion functions 310, and property graph storage functions, as described in connection with FIG. 3.

The lineage query processing module 1175 includes suitable circuitry, logic, interfaces, and/or code, and is configured to process data lineage queries and generate lineage query execution results using one or more property graphs. More specifically, the lineage query processing module 1175 can perform the same functions as the query translation module 325 and the graph visualization module 340, as described in connection with FIG. 3.

In some aspects, one or more of the modules 1160-1175 can be integrated as a single module, performing the corresponding functions of the integrated modules.

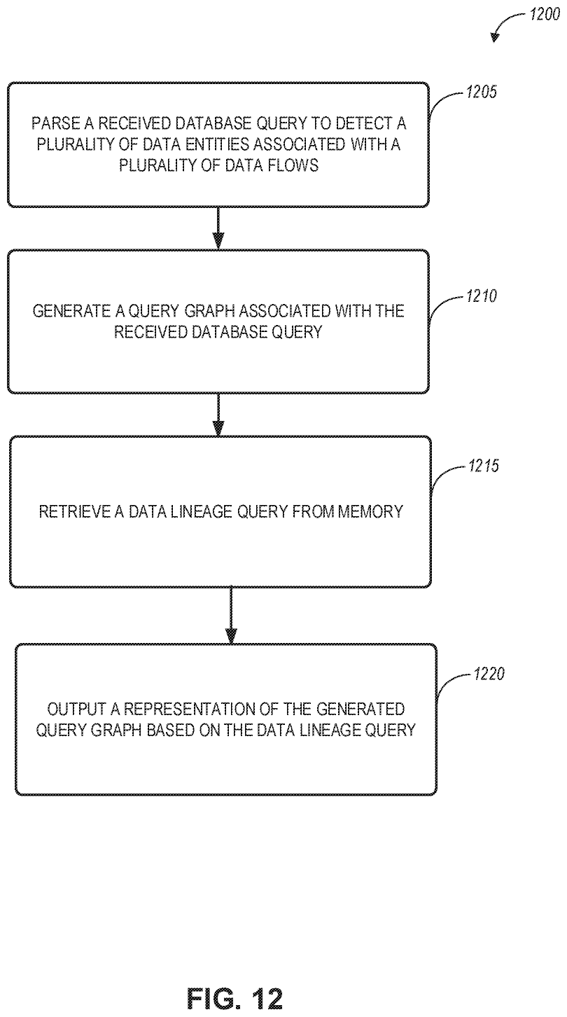

FIG. 12 is a flowchart of a method suitable for graph-based query analysis, according to some example embodiments. The method 1200 includes operations 1205, 1210, and 1215. By way of example and not limitation, the method 1200 is described as being performed by the device 1100 using the modules 1160-1175 of FIG. 12.

At operation 1205, a received database query is parsed to detect (e.g., identify) a plurality of data entities associated with a plurality of data flows. For example, the query parsing module 1160 can receive and parse query 805 to detect the data-related entities, data flows, transformations, and properties associated with the query 805.

At operation 1210, a query graph associated with the received database query is generated. For example, the property graph generation module 1170 can generate query graph 800 based on the data-related entities, data flows, transformations, and properties detected by the query parsing module 1160. The query graph 800 includes a plurality of nodes (e.g., 810, 815, 820, 825, and 830) connected via edges, where the plurality nodes correspond to the plurality of data entities and the edges correspond to the plurality of data flows.

At operation 1215, a data lineage query is retrieved from memory. The data lineage query includes one or more of the plurality of data entities associated with the plurality of nodes within the generated query graph. For example, the lineage query processing module 1175 retrieves (e.g., from volatile memory 1145 or non-volatile memory 1150) a lineage query 280 originating from a user (e.g., a data inspector) 205B. The lineage query processing module 1175 translates the query into a query graph language (e.g., using graph query algorithms 330).

In aspects when the data lineage query does not include data entities associated with the generated query graph, the lineage query processing module 1175 can retrieve another query graph (or a property graph based on multiple aggregated query graphs) from property graph storage 275, with the retrieved query graph including the data entities within the data lineage query.

At operation 1220, the lineage query processing module 1175 outputs a representation of the generated query graph based on the data lineage query. For example, the lineage query processing module 1175 executes the translated data lineage query by using one or more property graphs stored within storage 275 to generate lineage query execution results 335. The lineage query processing module 1175 uses the graph visualization module 340 to generate final results 290 that can be returned to user 205B.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above regarding any one or all of the steps of the disclosure can be installed in and sold with one or more computing devices consistent with the disclosure. Alternatively, the software can be obtained and loaded into one or more computing devices, including obtaining the software through physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components outlined in the description or illustrated in the drawings. The embodiments herein are capable of other embodiments and capable of being practiced or carried out in various ways. Also, it will be understood that the phraseology and terminology used herein is for description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Also, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems, and methods employed by the illustrated embodiments can be implemented, at least in part, in digital electronic circuitry, analog electronic circuitry, or computer hardware, firmware, software, or in combinations of them. These components can be implemented, for example, as a computer program product such as a computer program, program code or computer instructions tangibly embodied in an information carrier, or a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or another unit suitable for use in a computing environment. A computer program can be deployed to be executed on one computer or multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code, or instructions to perform functions (e.g., by operating on input data and/or generating an output). Method steps can also be performed by, and apparatus for performing the methods can be implemented as, special purpose logic circuitry, e.g., an FPGA (field-programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” (or “computer-readable medium”) means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors (e.g., processor 1105 in FIG. 11), such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

Although the present disclosure has been described concerning specific features and embodiments thereof, it is evident that various modifications and combinations can be made thereto without departing from the scope of the disclosure. For example, other components may be added to, or removed from, the described systems. The specification and drawings are, accordingly, to be regarded simply as an illustration of the disclosure as defined by the appended claims, and are contemplated to cover any modifications, variations, combinations or equivalents that fall within the scope of the present disclosure. Other aspects may be within the scope of the following claims.

What is claimed is:

1. A computer-implemented method of determining data lineage based on database queries, the method comprising:
receiving a database query and parsing the received database query to identify a plurality of data entities associated with a plurality of data flows;
generating a query graph based on the received database query, the query graph including a plurality of nodes connected via edges, wherein the plurality nodes correspond to the plurality of data entities and the edges correspond to the plurality of data flows;
retrieving a data lineage query from memory, the data lineage query including one or more of the plurality of data entities associated with the plurality of nodes within the generated query graph; and
outputting a representation of the generated query graph based on the data lineage query.

2. The computer-implemented method of claim 1, further comprising:
retrieving at least a second query graph, wherein the second query graph includes at least one node that is common with the generated query graph.

3. The computer-implemented method of claim 2, wherein the at least one node that is common with the generated query graph includes at least one of the following: a data table, a table column, a data view, a query result set, and a user-defined function.

4. The computer-implemented method of claim 2, further comprising:
generating a combined property graph based on the query graph and the second query graph, wherein the combined property graph traces data lineage of data from a starting node within the query graph through the at least one common node and terminating at a node that outputs a final representation of the data.

5. The computer-implemented method of claim 4, further comprising:
outputting a graph visualization or JavaScript Object Notation (JSON) using the combined property graph and based on the data lineage query, wherein the graph visualization is based on at least one portion of the combined property graph that includes nodes corresponding to the plurality of data entities referenced in the query.

6. The computer-implemented method of claim 1, further comprising:
translating the data lineage query into one or more graph query languages compatible with the generated query graph.

7. The computer-implemented method of claim 1, further comprising:
detecting a plurality of attributes for the plurality of data entities; and
appending the plurality of nodes corresponding to the plurality of data entities with the plurality of attributes.

8. The computer-implemented method of claim 1, further comprising:
validating the received database query prior to the parsing; and
executing the validated query to generate a query report.

9. The computer-implemented method of claim 8, wherein the validated query is executed concurrently with generating the query graph.

10. The computer-implemented method of claim 8, further comprising:
detecting one or more of the plurality of data flows are associated with data operations that manipulate data without affecting the query report.

11. The computer-implemented method of claim 10, further comprising:
excluding the one or more of the plurality of data flows from the query graph.

12. The computer-implemented method of claim 1, wherein the database query includes a nested query, and one of the plurality of nodes within the query graph is associated with a structured query language (SQL) operation of the nested query.

13. A device comprising:
a memory storage comprising instructions; and
one or more processors in communication with the memory storage, wherein the one or more processors execute the instructions to cause the device to perform operations comprising:
receiving a database query and parsing the received database query to identify a plurality of data entities associated with a plurality of data flows;
generating a query graph based on the received database query, the query graph including a plurality of nodes connected via edges, wherein the plurality nodes correspond to the plurality of data entities and the edges correspond to the plurality of data flows;
retrieving a data lineage query from memory, the data lineage query including one or more of the plurality of data entities associated with the plurality of nodes within the generated query graph; and
outputting a representation of the generated query graph based on the data lineage query.

14. The device of claim 13, wherein the one or more processors execute the instructions to perform operations further comprising:
retrieving at least a second query graph, wherein the second query graph includes at least one node that is common with the generated query graph.

15. The device of claim 14, wherein the one or more processors execute the instructions to perform operations further comprising:
generating a combined property graph based on the query graph and the second query graph.

16. The device of claim 15, wherein the one or more processors execute the instructions to perform operations further comprising:
outputting a graph visualization or JavaScript Object Notation (JSON) using the combined property graph and based on the data lineage query.

17. The device of claim 13, wherein the one or more processors execute the instructions to perform operations further comprising:
detecting a plurality of attributes for the plurality of data entities; and
appending the plurality of nodes corresponding to the plurality of data entities with the plurality of attributes.

18. The device of claim 13, wherein the one or more processors execute the instructions to perform operations further comprising:
detecting one or more of the plurality of data flows are associated with data operations that manipulate data without affecting a query report resulting from executing the database query; and
excluding the one or more of the plurality of data flows from the query graph.

19. A non-transitory machine-readable medium storing instructions for determining data lineage based on database queries, that when executed by one or more processors, cause the one or more processors to perform operations comprising:
receiving a database query and parsing the received database query to identify a plurality of data entities associated with a plurality of data flows;
generating a query graph based on the received database query, the query graph including a plurality of nodes connected via edges, wherein the plurality nodes correspond to the plurality of data entities and the edges correspond to the plurality of data flows;
retrieving a data lineage query from memory, the data lineage query including one or more of the plurality of data entities associated with the plurality of nodes within the generated query graph; and
outputting a representation of the generated query graph based on the data lineage query.

20. The non-transitory machine-readable medium of claim 19, wherein upon execution, the instructions further cause the one or more processors to perform operations comprising:
detecting a plurality of attributes for the plurality of data entities; and
appending the plurality of nodes corresponding to the plurality of data entities with the plurality of attributes.
